(19) United States
(12) Patent Application Publication
(10) Pub. No.: US 2009/0019634 A1
(43) Pub. Date: Jan. 22, 2009

(54) Steam bath cabinet

(76) Inventor: Toivo Lipponen, Kuopio (FI)

Correspondence Address: HARRINGTON & SMITH, PC, 4 RESEARCH DRIVE, Suite 202, SHELTON, CT, 06484-6212, US

(21) Appl. No.: 12/283,994

(22) Filed: Sep. 17, 2008

Related U.S. Application Data
(63) Continuation of application No. PCT/FI2007/000066, filed on Mar. 16, 2007.

(30) Foreign Application Priority Data
Mar. 17, 2006 (FI) 20060254

(51) Int. Cl. A61H 33/06

(52) U.S. Cl. 4/524

(57) ABSTRACT

A steam bath cabinet for one or several persons including a floor, walls, a ceiling and close able door being open able as well as a bathing compartment formed inside the steam bath cabinet and a technical compartment housing the steam generator equipment for generating the steam to be led into the bathing compartment. The steam bath cabinet in accordance with the invention is characterized in that a partition is provided between the bathing compartment and technical compartment to segregate the bathing compartment from the technical compartment in a steam- and water-proof manner and that the capacity of free steam space of the bathing compartment of the steam bath cabinet is no more than 0.6 m³ per person.

This application is a continuation of International Patent Application No. PCT/FI2007/000066 filed on Mar. 16, 2007.

### FIELD OF THE INVENTION

The present invention relates to a steam bath cabinet for one or several persons, said steam bath cabinet comprising a floor, walls, a ceiling, a close able door being open able, and a bathing compartment to be formed inside the steam bath cabinet and a technical compartment housing the steam generation equipment for producing the steam to be led to the bathing compartment.

### BACKGROUND OF THE INVENTION

The steam bath cabinet is a device designed for washing and relaxation and it is ideal for locations where a special steam cabin or sauna cannot be built because of lack of space or for some other reason. Steam bath cabinets have been used in various parts of the world for a relatively long time. Known steam bath cabinets are usually intended for one person, so that the steam compartment built therein is designed for a single bather. Normally, the bather does not go inside the steam compartment completely; instead, in the top section (ceiling) of the cabinet there is an opening allowing the bather to keep his or her head outside the steam bath cabinet during bathing while the rest of the body remains inside the steam bath cabinet.

Known steam bath cabinets have relative large steam compartments and often poor thermal insulation. For this reason, the problem with such cabinets is that they require quite a lot of heat and an unnecessarily long heating period to achieve a steam bath of even a moderate temperature. Large steam bath cabinets are also difficult to move. Steam bath cabinets with large bathing compartments take up a lot of space and suffer major thermal losses. Often relocating a steam bath cabinet is complicated because the steam bath cabinet and the steam generator required for producing the steam are separate units and the steam has to be led from a separate steam generator to the steam bath cabinet via pipes.

The seats provided in the bathing compartment of the steam bath cabinet are designed to provide seating and maximum relaxation during a steam bath. Usually the seats are mounted onto the floor of the steam bath cabinet or fixed to the wall that then serves as the backrest. There are seats with reclining backrests providing a sitting position that is tilted backwards relative to the horizontal plane. When sitting on such a seat, the bather is able to relax without straining. In order to make the free steam space within the steam bath cabinet as small as possible while providing the bather with fresh air for breathing, it would be advisable to have the bather's head completely outside the steam compartment. At this point, problems may arise with adjusting the seat for bathers of different height or size. Another problem often associated with existing steam bath cabinets is that the seat structures need to be built in such a way that the cleaning and washing of the steam bath cabinet and the seat, particularly in the back, are complicated.

For example, seniors and people with physical handicaps may find it difficult, if not impossible, to use many of the existing steam bath cabinets without help because many known steam bath cabinets have poor ergonomic design. What is more, steam bath cabinets would be used more extensively if the ergonomics were better and they would be easier to move and use than the existing steam bath cabinets. Furthermore, the existing steam bath cabinets have a fairly large free steam space (i.e., the space inside the bathing compartment limited by the internal surfaces of the bathing compartment inside the steam bath cabinet, such as walls, floor, ceiling and the close able door being open able, but even so, there is fairly little room for the bather to move during bathing. As a result, it is difficult to generate airflows within the bathing compartment of the steam bath cabinet equivalent to flailing with birch twigs because the bather has so little room to move.

The object of the invention is to provide a steam bath cabinet for eliminating disadvantages associated with the known steam bath cabinets. Especially, the object of the invention is to provide a steam bath cabinet in which steam space is as small as possible for achieving as good energy economy as possible but in which, however, the bather have enough room to move and in which the bather feels himself/herself comfortable and as relaxed as possible. Additionally, the object of the invention is to provide a steam bath cabinet that is small in size, takes up relatively little space and is easy to move. Furthermore, the object of the invention is to provide a steam bath cabinet which is ergonomic and in which the amount and flow of steam can be adjusted in a variety of ways despite the fact that the steam generation equipment is compact in size, takes up little space, and has low energy consumption.

### SUMMARY OF THE INVENTION

Characteristic to the steam bath cabinet in accordance with the invention is that a partition is provided between the bathing compartment and the technical compartment to segregate the bathing compartment from the technical compartment by providing a steam- and waterproof barrier between the two and that the maximum capacity of the free steam space within the steam bath cabinet is 0.6 m³ per person. Due to the partition, the capacity of the free steam space can be easily limited to under 0.6 m³ per person. Consequently, the proposed steam bath cabinet is considerably smaller than cabinets not fitted with a partition but still big enough not to make the bathing compartment too cramped and uncomfortable for the bather(s). Thanks to the small size of the free steam space, it is not necessary to generate as much steam as for the existing known steam bath cabinets. Due to the lower amount of steam required the steam generator might consist of a compact steam generator with low output that takes up little space and consumes little energy.

In one of the embodiments of the steam bath cabinet in accordance with the invention the partition is thermally insulated and formed in the shape of a seat and placed between the bathing and technical compartments in a position compatible with the seat to be installed in the bathing compartment. Consequently, a minimum amount of empty air/steam space is left behind the seat to be installed in the bathing compartment, and so the bathing space can be provided where it offers maximum comfort to the steam-bather. The thermal insulation prevents the steam from condensing on the inner surface of the partition, which reduces the need for steam even further.

In one of the embodiments of the steam bath cabinet in accordance with the invention the bathing compartment comprises a control device for regulating the amount and flow of steam. The control device can be used to adjust the steam flow fed to the bathing compartment smoothly and evenly so that the temperature and humidity of the bathing compartment remain constant and no excessively hot or cold areas are formed within the bathing compartment.

In one of the embodiments of the steam bath cabinet in accordance with the invention the bathing compartment comprises adjustable steam nozzles that can be used to direct the jet of steam produced by the steam generator to the preferred direction during bathing. With these steam nozzles, the steam can be directed to the bathing compartment in such a way that it heats the bathing compartment as evenly and safely as possible. Additionally, the steam nozzles make it possible to direct the steam according to the needs and preferences of individual bathers.

### BRIEF DESCRIPTION OF THE DRAWINGS

Next, the invention will be explained in more detail with reference to the accompanying drawings, in which,

FIG. 1 illustrates a longitudinal cross section of the steam bath cabinet in accordance with the invention,

FIG. 2 illustrates an oblique front view of the steam bath cabinet in accordance with the FIG. 1, and

FIG. 3 illustrates a longitudinal cross section of another steam bath cabinet in accordance with the invention.

### DETAILED DESCRIPTION OF THE DRAWINGS

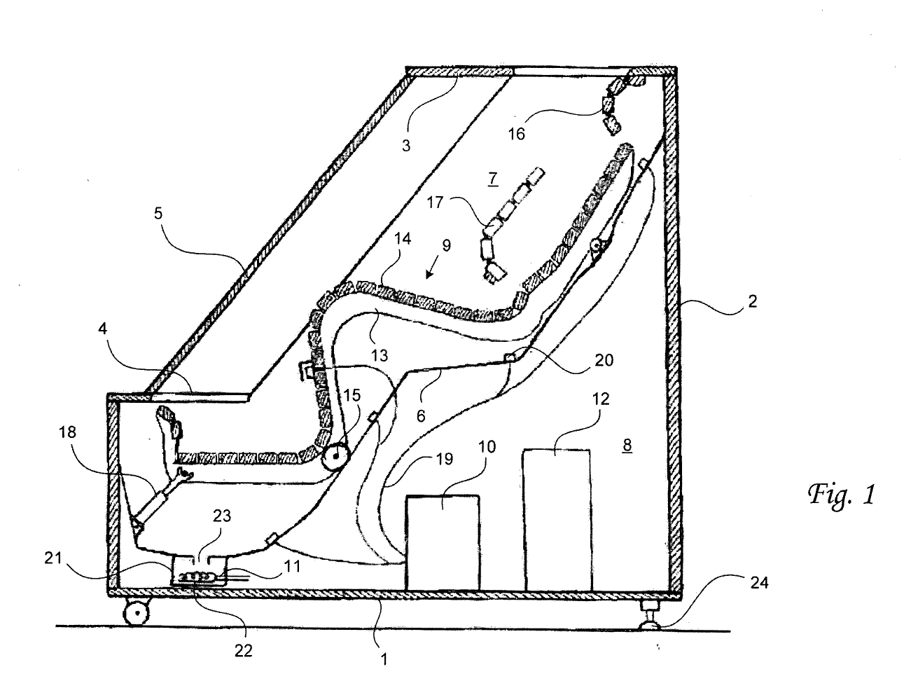

The steam bath cabinet shown in FIG. 1 comprises a floor 1, walls 2 and a ceiling 3 and a door 5 hung in the opening 4 provided in the front wall. Inside, the steam bath cabinet is divided into a bathing compartment 7 and technical compartment 8 by means of a water- and steam-proof partition 6. Additionally, the steam bath cabinet in accordance with the invention includes a seat 9, steam generator 10, heating device 11 and control unit 12 as well as the wheels 24 mounted to the base of the steam bath cabinet to make it easier to move it. Furthermore, the steam bath cabinet shown in FIG. 1 includes, among other things, the steam nozzles placed in the bathing compartment and the steam feeder canals inter-connecting the steam generator and the steam nozzles (not shown).

The floor 1, walls 2, ceiling 3 and door 5 of the bathing compartment 7 are in this case made of coated metal sheeting with a moisture-resistant polyurethane insulation on the inside that prevents the ingress of moisture and heat to the inner surface of the metal sheet placed on the outside. For example, this thermal insulation may consist of polyurethane sheets or the thermal insulation can be provided by spraying, extruding or casting polyurethane on the inner surfaces of the metal sheets. In order to ensure adequate moisture resistance, the inner surface of the polyurethane insulant (the surface facing the inside of the steam bath cabinet) is coated with a known paint that withstands the moisture and thermal stresses in the steam compartment. The tightness of the joints in the wall is ensured by the application of polyurethane foam to the joints after the wall units have been attached to another but before finishing the inner surface.

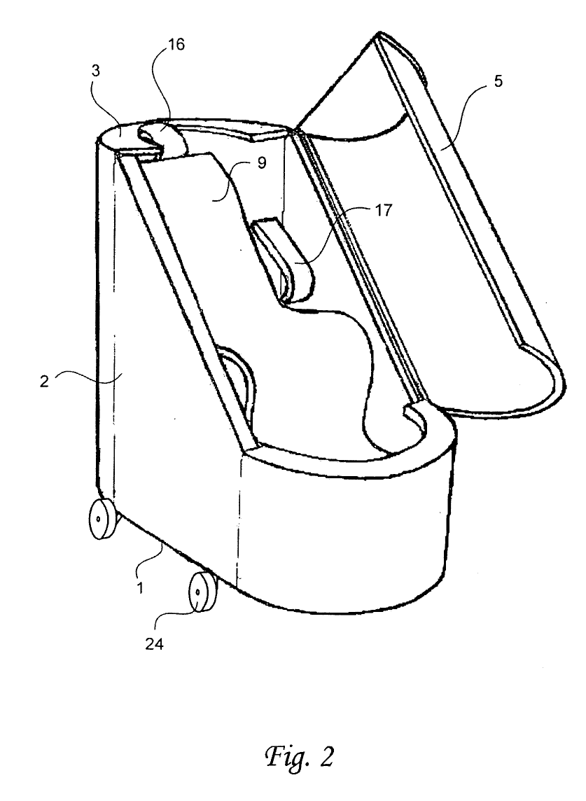

The door 5 as shown in FIG. 2 is curved and slightly housing-like in shape with the sides slightly extending over the sidewalls. This makes the opening large enough to allow easy access to the steam bath cabinet without making the joint between the door and walls unnecessarily long and the door large and heavy. Additionally, a suitable seal made of rubber or plastic (fixed to the edge of the wall) is provided between the door 5 and walls 2 to ensure that the door can be closed and made steam-proof during operation. The door is hung on known hinges mounted to the edge of the door opening while latches of a known type are provided on the opposite sides of the hinges, said latches being capable of being opened from the inside or outside of the steam bath cabinet and making it possible to close the door firmly during bathing and to open it easily and quickly when necessary.

The partition 6 between the bathing compartment and the technical compartment is in this embodiment shaped to resemble a seat so that it, at the same time, serves as a supporting surface for the seat 9. In this embodiment, the partition is made of sufficiently stiff and strong metal plate to ensure that it can absorb the load exerted by the moving seat 9 supported on rollers to be installed on top of the partition.

In this case, the seat 9 consists of a single piece shaped to resemble a recliner. It comprises two metal frame beams 13 shaped like a seat and wooden seat battens 14 placed in between as well as the rollers 15 mounted to the frame beams, the seat being supported on the partition 6 by means of said rollers as shown in FIG. 1. Additionally, the bathing compartment includes a neck rest 16 and armrests 17, also made of wood. Furthermore, the bathing compartment includes a spindle electric motor 18 mounted between the seat and the front wall of the steam bath cabinet for moving the seat upwards and downwards along the partition in an oblique direction according to the travel of the moving head of the spindle motor to adjust the height of the seat. Control switches are provided in the lower part of the armrests 17 to start and stop and steam generator 10 and heating device 11 from inside the steam bath cabinet, to adjust the height of the seat 9, and to move the steam bath cabinet if the steam bath cabinet is fitted with a moving mechanism operated by an electric motor.

In the technical compartment 8 behind the partition 6 there is a steam generator 10 that is a steam bath cabinet steam generator of a known type as far as its structure and operation are concerned. Steam feeder canals 19 are provided leading from the steam generators to the steam nozzles 20 mounted in the openings made in the partition 6, placed as shown in FIG. 1. A separate heating device 11 is provided in the technical compartment in a position corresponding to that of the lower part of the seat. The heating device comprises a protective housing 21 open at the top positioned against the lower surface of the partition and inside the protective housing there is an electric resistor 22. The heat generated by the electric resistor is released through the holes 23 provided in the partition at the location where the protective housing is placed. The electric resistor is of a known type in terms of structure and it can be used to heat the air inside the housing, which is then transmitted to the bathing compartment once heated. Additionally, the electric resistor can be used for drying the condensate and water finding its way to the bottom of the steam bath cabinet.

Additionally, the technical compartment of the steam bath cabinet in accordance with FIGS. 1 and 2 comprises a control unit 12. It includes a metal casing housing the control switches for the steam generator 10, heating device 11, and electric spindle motor. Also, the control unit includes, among other things, a power source of a known type for the spindle motor. Furthermore, the control unit includes a computer of a known type and a micro-controller that can be used for controlling the steam generator 10, heating device 11, and the spindle motor 18 moving the seat 9 by means of a programme installed in the computer.

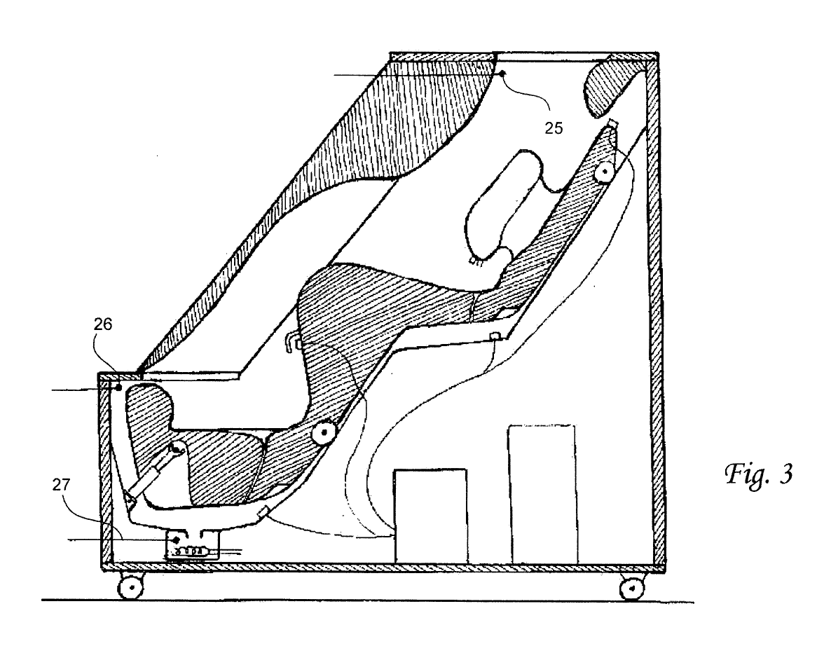

With regard to a number of details, the steam bath cabinet in accordance with the invention can be implemented differently. The floor, walls and ceiling and door of the steam bath cabinet should preferably be thermally insulated so that a minimum of 50% of the joint surface is sealed to provide water- and steam-proof joints. The insulation of the floor, walls and ceiling can be applied to the structures to be insulated, either from the side of the steam compartment or outside it depending on the material that the surfaces surrounding the steam compartment are made of. Instead of polyurethane, the thermal insulation may consist of cork, glass wool, polystyrene or other thermal insulation or material commonly used in similar equipment or structures. In FIG. 3, the embodiments shown in FIGS. 1 and 2 are provided with a relatively thick seat. As a result, the bathing compartment can be reduced in size without making it cramped. Due to the smaller bathing compartment, the required amount of steam can be reduced, meaning that the energy consumption of the steam bath cabinet can be decreased as compared to the embodiments shown in FIGS. 1 and 2.

In order to reduce the amount of steam required for a steam bath low enough for the relatively low-energy steam generator included in the steam bath cabinet, the free steam space in the steam bath cabinet in accordance with the invention is normally less than 0.4 m³, but even a steam bath cabinet with a free steam space of 0.6 m³ makes it possible to generate the required amount of steam with the relatively low-energy steam generator and to achieve the energy consumption values typical of the steam bath cabinet in accordance with the invention.

In some cases, the inside or outside of the steam bath cabinet can be clad with wood, metal, rubber, cork, ceramic materials, cloth, leather and/or plastic. Additionally, the different materials can be coated with a water repellent agent and made resistant to stresses caused by mould and moisture. At the bottom of the steam compartment there may be a water collection vessel for condensate and the water used for washing or this water can, in some cases, be led to a separate sewer system and/or dried with a separate heating device after the bath and washing.

The seat in the bathing compartment may in some cases be adjustable so that bather's head can be positioned in a certain location in the steam bath cabinet according to his or her body size. As a rule, it is advisable that the head can be kept outside the steam bath cabinet completely. Another way of ensuring adjustability in view of different-sized bathers is to make the top section of the steam bath cabinet adjustable, in which case the seat can be permanently fixed in position. These adjustments can be made using detachable raiser blocks or electrically controlled spindle motors, pneumatic or hydraulic cylinders, or a seat or seat parts capable of being adjusted with electric motors. In some cases, the seat can be supported on a moving device or rest, at one or several points, on slide guides, wheels, rollers or sliding surfaces. As the self-weight of the seat is enough to ensure the downward movement, the actuator required to move the seat can consist of a single-action pneumatic or hydraulic cylinder. In come cases it is, however, advisable to implement the moving device in such a way that it both pulls and pushes the seat in the preferred direction, especially if the seat is light in weight. Similarly, the height of the top section of the steam bath cabinet can be adjusted with similar moving devices and by mounting the top section on slide guides, wheels, rollers or sliding surfaces resting on the lower section of the steam bath cabinet.

In optimum conditions, the temperature in the free steam compartment is around 40 . . . 50° C. and relative humidity around 60 . . . 100%, or the temperature around 50 . . . 60° C. and relative humidity around 40 . . . 95%, or the temperature around 60 . . . 70° C. and relative humidity around 30 . . . 80%, or the temperature around 80 . . . 90° C. and relative humidity around 20 . . . 70%, or the temperature around 90 . . . 100° C. and relative humidity around 10 . . . 60%. The adjustment of the temperature and relative humidity in the bathing compartment can also be implemented in such a way that temperature and humidity can be adjusted during bathing. In an embodiment, the control of the steam bath cabinet can be implemented in such a way that the steam bath cabinet can be used for applying various therapeutic and health treatments, such as weight-loss programmes or steam baths, therapy and treatment sessions, rest periods and any combination of these. The steam bath cabinet in accordance with the invention can also be used for opening the skin pores before application of various skin care or other such agents, when the steam bath cabinet is, for example, fitted with a separate controller or a pre-programmed computer application designed for such a purpose. Additionally, a steam bath cabinet in accordance with the invention may have shower equipment for rinsing and/or washing the bather during the steam bath. Furthermore, an embodiment of the steam bath cabinet in accordance with the invention may have air nozzles placed in the bathing compartment to provide air massage during the steam bath and to dry the bather with warm air after the steam bath.

The floor of the steam bath cabinet and, possibly, its walls and/or ceiling are vertical or angled surfaces to allow any condensate or any water used for washing to be drained to a preferred small area in the lower part of the steam compartment even if the steam bath cabinet were not in a correct position on its base. This will facilitate drainage, collection and evaporation of the condensate and washing water from the bottom of the steam bath cabinet. It is advisable to design the flat bottom of the lowest part of the steam bath cabinet floor in such a way that its area is less than 0.2 m² when the steam bath cabinet is in the position indicated in the installation instructions. Also, the floor of the steam bath cabinet can be designed in such a way that, when the position of the cabinet is adjusted as indicated in the installation instructions, the area of water pool created by 2 dm³ of water poured on the flat surface at any site within the steam compartment always remains less than 0.1 m². If a drainage or collection area is provided in the bottom of the steam compartment, at least 1.9 dm³ of said 2 dm³ amount of water must find its way, when poured at any site on a flat surface within the steam bath cabinet, to such a drainage or collection site when there are no obstacles en route and when the steam bath cabinet is adjusted in the position indicated in the installation instructions.

Airflow comparable to bathing with birch-twigs can be provided, from example by reducing the steam space in the bathing compartment, which will direct the steam more effectively to the bather's skin. Such reduction can be achieved by dividing the bathing compartment into smaller sections by means of dividers, but separate airflow guides can also improve this effect. With such a solution, the airflow can be adjustable with separate guides or pre-programmed application either during bathing or in advance. With the dividers, it is possible to create different humidity and temperature conditions in different parts of the bathing compartment. The dividers may consist, for example, of polystyrene-insulated plastic divisions or any suitable wood with as high thermal insulation capacity as possible. The dividers may also consist of rubber or various fabrics, such as those used for making towels. With the dividers, the bathing compartment can be divided in such a way that the legs and torso are in their own separate sections, or so that the arms and legs are in a space of their own separate from the rest of the body. Also, the steam space in the bathing compartment can be further reduced by using various elastic pneumatic pads or similar items or by having the bather wear a special bathing suit provided with dividers designed according to the bather and the steam bath cabinet.

Normally access to and exit from the steam bath cabinet is by means of the open able door. The door can be opened either from the top or side of the steam bath cabinet. The door can also be of the lifting, overhead or sliding type. The door can also be mechanically operated allowing the door to be opened and closed with a separate controller, a pre-programmed computer application, etc.

As a rule, the seat is tilted backwards at a minimum angle of 5° relative to the horizontal plane, and the highest point of the front of the seat is higher than the lowest point of the seat. The partition wall in the steam bath cabinet can serve as the backrest, or the backrest may consist of a separate backrest supported against the partition. The separate backrest can be tilted backwards relative to the vertical plane. Preferably, the angle of the backrest is at least 10° backwards relative to the vertical plan, and the high intersection point of the backrest tangent is back of the low intersection point. In some cases, the seat can also be flat or tilted 0 to 5°, with or without a backrest. The seat may also be made in such a way that its backrest comprises sections at different angles relative to one another and at different angles relative to the vertical. Even so, the backrest as a whole will be tilted backwards. In some embodiment, the bather may also be standing inside the steam bath cabinet. The steam-bathing program may also include several phases during which the bather alternatingly stands and sits in the steam bath cabinet.

Movement of the seat can be implemented in such a way that it is easy to adjust according to the size of the bather without changing his or her sitting position. The bather's head can be adjusted in a position that is outside the steam space more or less in the same position irrespective of the height of the person by adjusting the height of the top section of the steam space without changing the seating or standing level. Height adjustment is carried out at a backward angle, nearly at the same angle at which the backrest is tilted backwards. This adjustment can also be made by replacing the seat or parts of it or by placing raiser blocks under the seat according to the height of the person involved. Additionally, the seats can be designed in such a way that, if necessary, they can be easily lifted from the steam bath cabinet for the duration of cleaning and to clean and wash the seat, particularly its rear sections.

In the embodiments shown in FIGS. 1 to 3, the ends of the steam pipes and/or hoses laid from the technical compartment to the bathing compartment are open, but in some cases they may have non-return valves and/or nozzles regulating the steam flow. Adjustment of the steam flow can be accomplished by choking the flow through each nozzle manually or by using separate steam-flow chokes controlled electronically, and/or pneumatically, and/or electro-magnetically. The steam nozzles may in some cases be capable of being turned in order to achieve the preferred steam flow. Before the steam nozzles there may also be flow guides that can be used to adjust the steam flow as desired. These steam generators, steam pipes and/or hoses and nozzles may, in some cases, be insulated with polyurethane or in other similar ways as explained in the foregoing.

In addition to the steam generator, heating device and control unit, the technical compartment may contain a washer and disinfection device to clean, disinfect and dry the steam bath cabinet before or after the steam bath. Additionally, the steam bath may include other necessary instruments and equipment, including batteries required for controlling lights. etc., if audio and video equipment is to be installed in connection with the steam bath cabinet. Furthermore, such equipment may consist of accessories for controlling the nozzles and flow guides, adjusting the temperature and humidity in the steam space, regulating the temperature of, and drying, the technical compartment, drainage system and the lower part of the steam compartment, opening and closing the door, moving the steam bath cabinet, adjusting the steam bath cabinet seat, armrests and neck rest, generating and controlling compressed air and controlling the washer and disinfection device.

The steam bath cabinet in accordance with the invention provides so good energy efficiency that the steam generator may consist of a generator powered by electrical energy stored in batteries. In order to ensure a sufficient power level, it would be advisable to have a battery with a voltage of 24V, but a 12V system is feasible in many cases. A steam bath cabinet using such a power system will not require moisture and other such safety systems as systems operating on the 110V or 220V mains voltage. The batteries of this type of steam bath cabinet can be recharged with mains recharges or, for example, with solar panels/cells if mains power is not available. The solar panels/cells can be mounted on a separate stand and/or they can be attached to the outer surface of the steam bath cabinet. With this type of embodiment, the other steam bath cabinet functions can also be made to operate with power drawn from batteries.

Instead of electricity, liquefied gas or methylated spirits or other such liquid fuel can power the steam generator. The advantage offered by such a generator is that a steam generator powered in this way can be used in conditions where no electricity is available.

The technical compartment of the steam bath cabinet in accordance with the invention may also contain a pressurised steam tank and/or hot-water reservoir that can be used for storing pressurised steam and/or thermal energy. Optimally, this type of steam bath cabinet can also be used in conditions where no electricity or functional steam generator is available. With the steam tank, it is possible to momentarily increase the maximum steam output of the steam generator. The hot-water reservoir can be used for preheating the water to be vaporised in the steam generator or for storing hot water. If so, the steam generator will not have to first heat up the water to be vaporised; instead, it is enough that the generator quickly increases the temperature of the water, already close to the boiling point, to the boiling point. This will reduce energy consumption by the steam generator and be of special advantage if the steam generator of the steam bath cabinet is battery-powered. Additionally, when the steam tank or hot-water reservoir is insulated efficiently enough, a heating device of relatively low output is enough to keep the water/steam hot. For example, with a battery-operated steam bath cabinet, the hot-water reservoir can be filled in advance with water preheated with a gas- or mains-operated boiler (also e.g. hot tap water). Then, the integrated heater of the hot-water reservoir does not have to be used for heating the water; instead, it is sufficient that enough heat is generated with the heating device to offset the loss through the thermal insulation of the hot-water reservoir.

The functions of the steam bath cabinet can in some cases be controlled with push buttons and/or controls located inside and/or outside the steam bath cabinet connected to the control equipment placed in the technical compartment either electrically, pneumatically or hydraulically. A steam bath cabinet provided with a computer can be controlled by means of pre-programmed computer programs by electing a suitable steam bath program for each individual case. The program can be selected with a coin, bank note, charge card, credit card or token-operated vending machine or by selecting a specific program code by pushing a button. In some cases, the steam bath cabinet can be controlled and/or adjusted according to the bather's temperature, blood pressure, breathing, pulse and energy consumption. The operation of the steam bath cabinet can also be fully manual or fully automatic based on programs, or a combination of the two. It is advisable to provide manual controls that can be used to suspend or change the automatic program when it is running. Similarly, it is advisable to have sensors to monitor the status of the steam compartment, technical compartment and the bather's condition (such as the sensors 25 to 27 of the embodiment shown in FIG. 3) that can control the functions of the steam bath cabinet and/or sound alarms, so that the bathers' safety is taken into account, for example in case of malfunction or if the bather suffers a seizure.

As a rule, the steam bath cabinet in accordance with the invention is provided with wheels to make it easy to move it to the preferred location when there are no bathers. The steam bath cabinet can also be provided with sufficiently strong and easily rotating wheels to make it possible to move the steam bath cabinet when there is a bather inside. Additionally, two or more steam bath cabinets in accordance with the invention can be placed side by side and steam generation can be arranged so that a single steam generator is used to generate steam for two or several bathing compartments. The steam bath cabinets could also be washed and disinfected using the same common washing and disinfection equipment.

1. A steam bath cabinet for one or several persons comprising
a floor, walls, a ceiling and a close able and open able door;
a bathing compartment formed inside the steam bath cabinet;
and a technical compartment housing for a steam generator equipment for producing a steam to be conducted into the bathing compartment;
the steam bath cabinet comprises a partition placed between the bathing compartment and the technical compartment to segregate the bathing compartment from the technical compartment in a steam- and water-proof manner;
the capacity of the free steam space of the bathing compartment of the steam bath cabinet is no more than 0.6 m³ per person; and
the steam bath cabinet includes a control device for adjusting the volume and flow of the steam.

2. A steam bath cabinet in accordance with claim 1, in which
the partition is provided with a thermal insulation;
the partition is formed mainly in a shape of a seat and mounted between the bathing compartment and the technical compartment in a position compatible mainly with the seat to be installed in the bathing compartment.

3. A steam bath cabinet in accordance with claim 1, in which
the bathing compartment includes adjustable steam nozzles the direction of which is adjustable to direct the steam generated by the steam generating equipment to a preferred location during bathing.

4. A steam bath cabinet in accordance with claim 1, including
a seat inside the bathing cabinet; and
the bathing compartment comprises at least one actuator to adjust the height of the seat.

5. A steam bath cabinet in accordance with claim 4, in which
the seat is divided into at least two parts that can be adjusted interpedently.

6. A steam bath cabinet in accordance with claim 1, in which
the bathing compartment comprises at least one divider wall to divide a free steam compartment into separate sections.

7. A steam bath cabinet in accordance with claim 1, in which
the technical compartment comprises a battery for storing the energy required for the steam bath cabinet.

8. A steam bath cabinet in accordance with claim 1, comprising
condensate water canals to collect water condensing on the steam bath cabinet walls.

9. A steam bath cabinet in accordance with claim 1, comprising
a heating device in the lower part of the bathing compartment for drying the bathing compartment after bathing.
